(19) United States
(12) Patent Application Publication
(10) Pub. No.: US 2020/0292148 A1
(43) Pub. Date: Sep. 17, 2020

(54) Systems and Methods to Produce a Linear Batwing Profile for LED Luminaires

(71) Applicant: Robert W. McCullough, Sausalito, CA (US)

(72) Inventor: Robert W. McCullough, Sausalito, CA (US)

(21) Appl. No.: 16/891,453

(22) Filed: Jun. 3, 2020

(51) Int. Cl. F21V 7/00; F21S 4/28

(52) U.S. Cl. CPC F21V 7/005; F21Y 2115/10; F21S 4/28

(57) ABSTRACT

The disclosed embodiments pertain to methods and systems for producing a uniform irradiance upon a horizontal surface using an array of LED emitters and optionally a reflective surface. The uniform irradiance upon a horizontal surface has utility in horticultural lighting applications where it is desirable to distribute energy from the lighting system uniformly to the crop canopy to ensure uniform growth rates and optimal usage of electrical power. Linear LED arrays may be disposed in parallel along a linear support structure with the angle of the arrays and the angle of the LED beams adjusted to comport with an even light distribution over the plant canopy or horizontal surface. The optical light patters achieved resemble and are sometimes called “batwings.”

### RELATED PATENT APPLICATION AND INCORPORATION BY REFERENCE

N/A

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally related to lighting systems for horticulture. More particularly, the invention relates to the design, manufacture and use of linear arrays of LEDs disposed upon an angled support structure and the LEDs having a predefined beam angle so as to deliver a relatively uniform or batwing flux density of illumination upon a horizontal surface or plant canopy.

(2) Description of the Related Art

The use of LED luminaires in various configurations is known in the prior art. But the prior art fails to disclose, suggest or teach a LED configuration that delivers a uniform quantity of light to a horizontal surface. Shortfalls in the related art require plants to be periodically moved or lights to be periodically moved to ensure even growth patterns. Thus, there is a need in the art for the presently disclosed embodiments.

### BRIEF SUMMARY OF THE INVENTION

The present invention overcomes shortfalls in the related art by presenting an unobvious and unique combination, configuration and use of linear arrays disposed upon an angled linear support structure so as to overcome shortfalls in the related art, wherein the related art often uses points of light that result in uneven lighting upon a plant canopy.

The presently disclosed embodiments overcome shortfalls in the art by use of linear arrays that span the entire, or close to entire horizontal length of a grow area. Thus, dark or less lighted areas along the length of the grow area are avoided. To achieve a uniform distribution of light along the width of a linear array, a batwing distribution of light is achieved by several disclosed embodiments.

In a first embodiment, a linear support structure may comprise two support planes normal to one another or each being about 45 degrees from vertical. A row or array of LEDs may be disposed upon each of the support planes. Each LED may have a beam of approximately 80 degrees. This configuration, as more completely describe herein, produces excellent results, in contraction to the prior art teachings of using lights, LEDs or bulbs disposed in straight downward position.

A second embodiment may comprise a mirror disposed above each of the support planes, so as to further focus the output of the LEDs. Each mirror may be normal to the other mirror or approximately 45 degrees from vertical.

A third embodiment may comprise one planar mirror disposed over an inverted LED support structure, such that two rows of LEDs are disposed upwardly at 45 or so degrees with the light reflecting upon the mirror above, causing the light to reflect downwardly in a batwing pattern.

A fourth embodiment may comprise two LED support structures in a vertical position with each array of LEDs pointing to a mirror angled at approximately 30 degrees.

A fifth embodiment may use a curved mirror or curved reflector

### BRIEF DESCRIPTION OF THE DRAWINGS

FIG. 1 depicts light produced from a point source element

FIG. 2 depicts a polar plot for a 1/cos³(θ) Batwing radiance distribution

FIG. 3 depicts a polar plot of radiance distribution for an 80° LED

FIG. 4 depicts a polar plot of radiance distribution for an 120° LED

FIG. 5 depicts infinite linear illumination along a horizontal plane

FIG. 6 depicts a polar plot for a 1/cos²(θ) Batwing radiance distribution

FIG. 7 depicts a first and second LED with a beam of 80 degrees disposed upon a support surface positioned at 45 degrees

FIG. 8 depicts the sum of the two systems of FIG. 7

FIG. 9 depicts a first disclosed embodiment

FIG. 10 depicts a second disclosed embodiment comprising two superior mirrors with each mirror normal to the other

FIG. 11 depicts a third disclosed embodiment comprising a single horizontal mirror superior to the LED arrays

FIG. 12 depicts a fourth embodiment comprising two linear LED arrays in vertical positions and reflecting light from a superior and angled mirror

FIG. 13 depicts a spherical distribution or absorption of light

FIG. 14 depicts a polar radiance plot for a Batwing distribution with a 1/cos(θ) angular variation

### REFERENCE NUMERALS IN THE DRAWINGS

100 first embodiment in general

200 linear array of LEDs

300 linear support structure for array of LEDs

310 first support plane for an array of LEDs

320 second support plane for an array of LEDs

400 mirror structure

410 a first mirror plane of a mirror structure

420 a second mirror plane of a mirror structure

500 aggregate light pattern from an entire system

510 aggregate light pattern from a first set of LEDs

520 aggregate light pattern from a second set of LEDs

530 light ray

These and other aspects of the present invention will become apparent upon reading the following detailed description in conjunction with the associated drawings.

### Detailed Description of Embodiments of the Invention

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The disclosed embodiments pertain to systems and methods for producing a uniform irradiance upon a horizontal surface using an array of LED emitters and optionally a simple reflective surface. The uniform irradiance on a horizontal surface has utility in horticultural lighting applications where it is desirable to distribute energy from the lighting system uniformly to the crop canopy to ensure uniform growth rates and optimal usage of electrical power. The discussion below will focus on the distribution of energy but applies equally well to a distribution of individual photons. We will use the terms flux, radiance and irradiance in the discussion, and they are defined as follows:

1. Flux—A flux is defined as a unit of quantity delivered per unit of time. For the case of energy flux, the units are joules (energy) per second which are also known as watts. We use Q to denote energy flux.

2. Radiance is defined as the flux of radiant energy per unit solid angle and the units are watts per steradian. We use R to denote radiances.

3. Irradiance is defined as the flux of radiant energy passing through an area or incident on a surface area and the units are watts per square meter. We use “I” to denote irradiance.

Illumination may be described from two ideal types of light sources: a point source and a line source. The energy flux from a point source is given in watts while that of a linear source is given in energy flux per unit length or watts per meter.

Illumination from a point source radiates in all directions. The intensity of the light decreases in proportion to the inverse square of the distance from the source. If such a source is used to provide illumination to a surface, the result is a bright spot directly under the light and a decreasing intensity as one moves outward from the spot under the light. This is the illumination pattern produced by single bare light bulb in a room. Ideally one would prefer to have the illumination be uniform over a horizontal surface. To this end, interior lighting devices use reflectors, diffusers and multiple sources to provide illumination. For interior illumination, the use of several lights can be pleasing to the eye even though the illumination is not uniform.

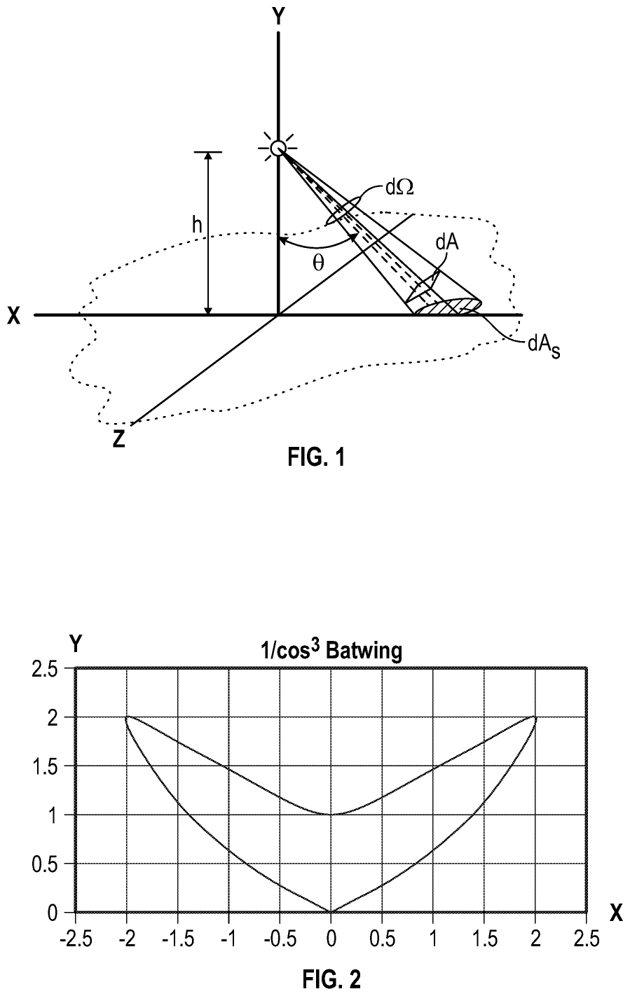

Referring to FIG. 1, the geometry of a simple point source is illustrated. A point source located at a height h above a plane horizontal surface. If the distribution of light is uniform in all directions, then the radiance, R, is simply given by the total flux divided by the steradiancy of a sphere or 4π. So R=Q/4π.

The energy flux dQ contained in a small solid angle dΩ is just given by dQ=R dΩ. The cross-sectional area, dA, of the small solid angle cone at a distance r from the source is just given by dA=r² dΩ. Since we can see from the disclosed geometry that the height from the source to the horizontal plane, h, is related to r by h=r cos(θ) where θ is the angle from the normal to the surface to the center of the beam. From this we can derive that the irradiance, I, through the differential area dA is given by I=R*cos²(θ)/h².

Note that the area illuminated on the horizontal surface, dAₛ, is larger than the normal area dA and is related by dAₛ=dA/cos(θ). This resulting expression for the irradiance on the horizontal surface is given by I=R cos³(θ)/h².

Referring to FIG. 2, if now we consider a point source whose radiance, R(θ), has directionality and is not uniform in all directions, but can vary with angle θ, then the irradiance on the horizontal surface is given by I(θ)=R(θ)cos³(θ)/h2. If we wish to achieve a uniform irradiance on the horizontal surface we note that the angular variation of the radiance must vary as 1/cos³(θ) in order to cancel out the cos³(θ) dependence in the formula.

FIG. 2 shows a polar plot of a radiance distribution with such a variation. This particular source is posited to have the distribution to θ=45 degrees and zero for larger angles. Notice that the shape of the distribution resembles a “batwing”, hence it is called a batwing distribution.

In some of the polar plots depicted herein, the units on a a polar plot are that the length of the radius is proportional to the units per angle and the angle is the other dimension (unit). For LED radiance polars the units should be watts per steradian. However, most manufacturers normalize the plots to theta=0 (vertical axis). That is what is shown in FIGS. 2-4 and 6-8. Thus, the units are normalized radiance per solid angle.

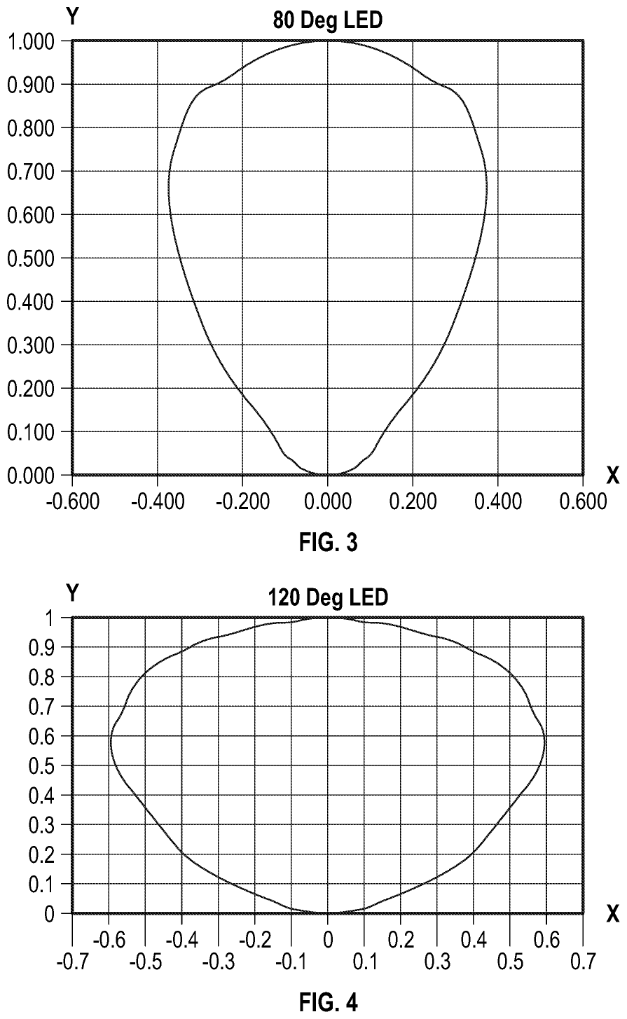

Consider the types of radiance distributions available in commercial LED chips. Many manufacturers offer products consisting of an LED die with a plastic lens that controls how the radiant flux is distributed. Typically, products are offered with a wide beam with a full width at half maximum (FWHM) of 120° or 150° or a narrow beam product with a FWHM of 80°. These distributions are shown on FIGS. 3 and 4 respectively. While this optical situation does collect the bulk of the flux and direct it in a useful direction, if an LED like this were used to illuminate a horizontal plane, it would produce a non-uniform irradiance on the plane with a bright spot in the middle.

It is a substantial challenge to convert a distribution such as that shown in FIG. 3 to that shown in FIG. 2. There are solutions using both refractive and reflective optics to achieve this, but they involve very sophisticated and expensive lenses and typically only operate over a limited range of elevations. If one were to invent a cost-effective device to accomplish this, the result would be a circular patch on the horizontal surface with uniform irradiance. Tiling a growth canopy with luminaires made this way would result in an inefficient pattern of uniform discs with dark zones in between.

For horticultural lighting, the requirement for uniform irradiance on the crop canopy is more stringent. Since the plants' growth rate is proportional to the incident flux, non-uniform illumination can have severe consequences. In many facilities, plants have to be manually rotated under the lights so that they all grow at the same rate. In other facilities costly mechanical systems are employed to move the lights around so that all of the plants receive uniform average irradiance over time.

The disclosed embodiments circumvent this issue by using a linear array of LEDs to approximate an ideal linear source. An ideal linear source is a line of light that stretches to infinity. Imagine a tungsten filament, such as that used in an incandescent light bulb but stretched out over a long distance. In such a geometry, variation in radiance or irradiance in the direction of the axis is non-existent. We then ask what type of polar distribution would produce the desired uniform irradiance on a horizontal surface beneath the linear source. Note that the units on the polar plot for this case are in terms of flux per linear angle per unit length of the source or watts per radian per meter. We shall denote this quantity L since it lies between radiance and irradiance.

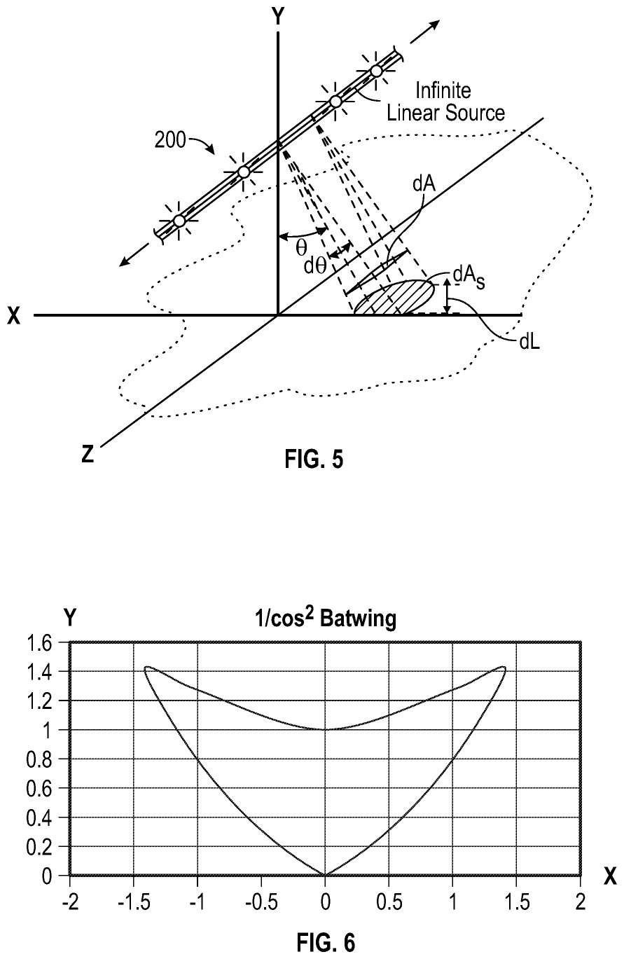

To understand the implications of this geometry, consider FIG. 5, which is analogous to the case of the point source shown in FIG. 1. For a source with a uniform output with respect to variations in θ, the irradiance on the small area patch dA normal to the beam is given by (J/r) dθ in watts per square meter. Since, as before r=h/cos(θ) we see that the radiance on dA is given by (J/h cos(θ)) dθ. To obtain the irradiance on the patch of area on the horizontal surface we see again that dA and dAs are related by dAs=dA/cos(θ), introducing again another factor of cos(θ) in to the formula. The net result is that if we wish a J distribution which produces a uniform radiance on the horizontal surface, it must vary as 1/cos²(θ). This type of distribution is illustrated in FIG. 6 for an ideal source that follows the required variation out to 45 degrees.

Referring to FIG. 5, again, the shape of the curve resembles a batwing, although less extreme. If we examine the irradiance pattern on the horizontal surface for this last case, we see a strip of finite width (due to the cut-off angle) that extends to infinity in the linear direction. This shape is well suited to “tiling” an extended surface and is a basis for the novelty of some of the disclosed embodiments.

In a current embodiment we approximate an infinite linear source by an array of LEDs closely packed and extending for 80 or more LEDs in a single circuit board. The actual use of such an array or a sequence of arrays will have non-uniform irradiance fields near the ends but will exhibit uniform irradiance over most of its length.

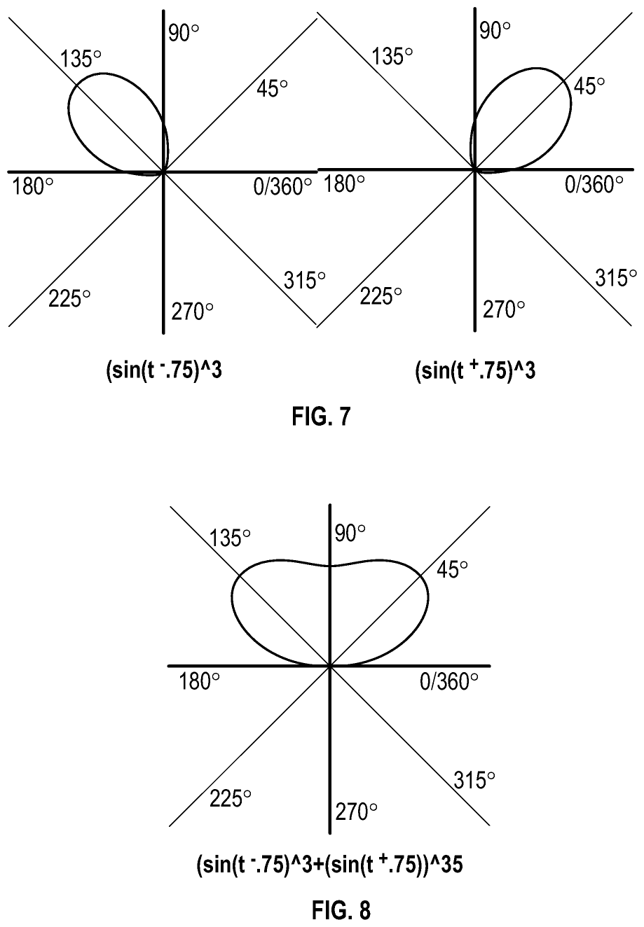

An important part of the disclosed embodiments or an enabling part of the disclosed embodiments resulted from the discovery that a pair of 80° LEDs angled apart will produce something resembling a batwing. To see this more clearly, we show two 80° radiance plots tilted from the normal in FIG. 7.

Note that these plots combined no longer have an axis of symmetry of the vertical axis. A complete plot would show two lobes angled apart. However, when we consider the effect of assembling two linear arrays of LEDs angled apart, the curve (500) shown in FIG. 8 would approximate the two-dimensional radiance curve discussed earlier and illustrated in FIG. 6.

By suspending a parallel series of linear arrays of lights spaced apart by the appropriate distance it is possible to produce a uniform flux density over a large area. If LEDs with a half angle of 80° are set in an array that projects their beams out at an included angle of 80°, then the half power points of both beams will intersect on the vertical axis, resulting in a batwing type of illumination.

Two caveats should be noted: First it is impossible to have an infinite series of lights. However, light fixtures can be positioned in rooms so that the array is long enough that end effects are tolerable. Second, it is impossible to cut off an energy distribution at a precise angle. Practical considerations yield curves that have tips that are rounded, not pointed.

The disclosed embodiments circumvent these difficulties by using a special type of LED and a simple linear reflector to produce an extremely uniform illumination of the plant canopy. The light fixtures start with linear arrays of LEDs so that the lights resemble fluorescent light tubes geometrically. If a number of lights are installed end-to-end, then the illumination variation along the installation axis is inherently uniform.

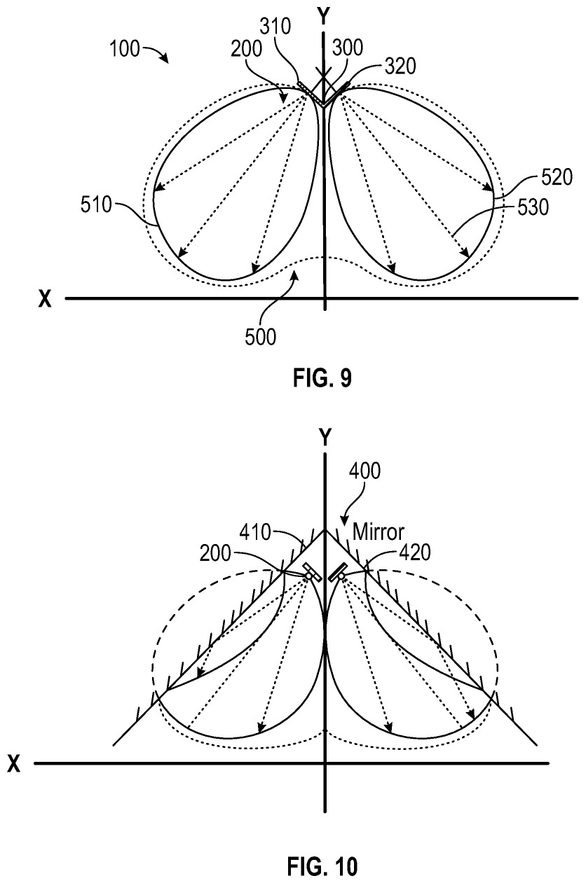

Transverse uniformity is achieved by using narrow-beam LEDs in the fixture. These LEDs have a FWHM angle of 80 degrees achieved via an integral lens on the LED. When two LEDs are arranged with their beam axes separated by 80 degrees, the resulting pattern resembles a batwing. Adding a 90-degree reflector above the array as shown in FIG. 9 captures light that would be lost to the sides and redirects it downward, making an almost perfect batwing pattern.

Optical ray trace computer programs have been used to predict the illumination patterns of our lights and to refine the angles of the LED supports and reflectors to optimize radiation pattern uniformity. In fact, simulations have been used to produce an optimum design in which the variation of irradiance across a horizontal plane was less than +/−5% across the width. Numerous ray-trace simulations were conducted to assess the geometry which resulted in a uniform flux density. This geometry and concept are what is claimed as the basis of the present patent.

The disclosed embodiments are scalable to any size fixture. In addition, the basic concept can be used to design batwing patterns using LEDs with wider distributions and batwings from a point source in place of a linear source. The optic required is a reflector, which in the case of the linear light is a simple flat surface. This is extremely cost-effective and can be manufactured from polished sheet metal or plastic mirror material.

The baseline geometry may comprise two linear arrays of narrow beam LEDs separated angularly to create a linear batwing profile. This arrangement is shown schematically in FIG. 9. In addition to the polar radiance plot, three optical rays are shown on each LED array. In the previous example the polar plots were combined assuming that the two sources occupied the same point, the origin. In real situations the LEDs reside on circuit boards and so the sources are separated by a small distance on the order of 1 cm. At distances from the LEDs on the order of this separation we have a near-field radiance profile which differs from the ideal. However, as we move away from the LED arrays into the far field the resulting polar distribution approximates that of the previous example. In practice the horizontal surface of the canopy will be at least 100 cm below the LED arrays assuring far field optics.

FIG. 9 presents a polar radiance distribution for two LED arrays oriented at an angle with respect to each other.

Referring to FIG. 10, Ray trace programs have indicated that the efficiency of the system can be increased by adding a 90° reflector to redirect some of the sidelobe energy back down to the edges of the illuminated surface on the horizontal plane. FIG. 10 illustrates this. Without the reflector about 20% of the energy is lost to the side walls.

Referring to FIG. 11, In fact, it is possible to use planar mirrors to allow the linear arrays to be oriented in any angle with respect to each other. FIG. 11 illustrates the LED arrays directed upward and reflected off a plane mirror back down on the horizontal surface. This arrangement may be desirable when the height of the roof is limited to allow a wider beam on the canopy.

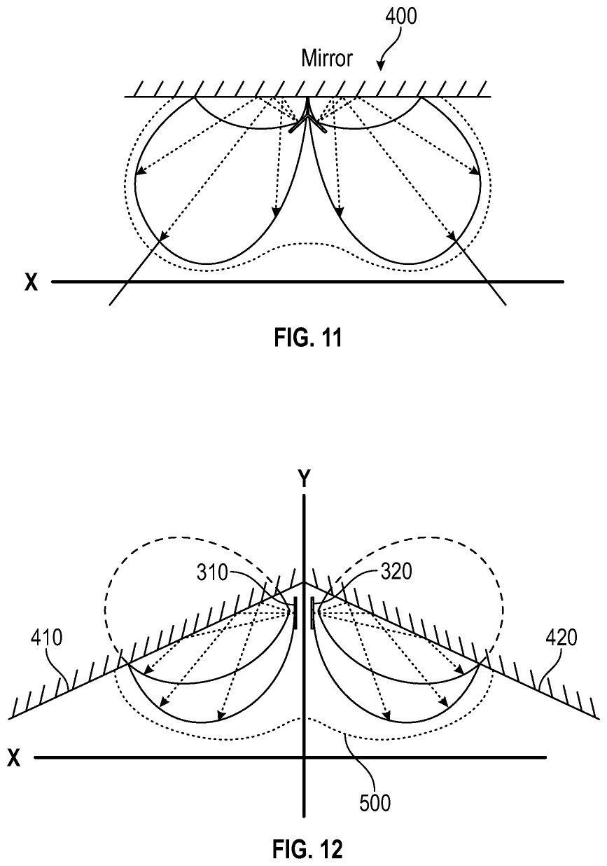

FIG. 12 illustrates the case in which the LED arrays are oriented in diametrically opposite directions and angled off a planar mirror that creates the desired angle of the beam centerlines with respect to each other. Many other combinations are possible and may have utility when considering how to best package the LED arrays into a production package.

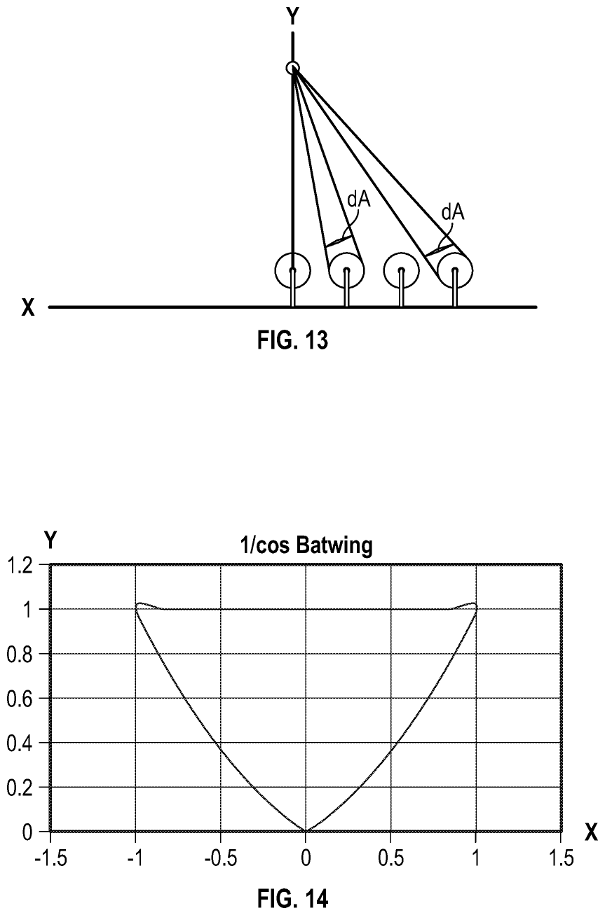

FIG. 13 illustrates a spherical plant absorber model. The prior models, i.e. from FIG. 9 are intended to provide a uniform irradiance upon a horizontal surface. A horizontal model would be ideal if plants were effectively flat plate collectors facing upwards. In most cases, individual leaves on plants do approximate this geometry so it is a good design goal. It is worth noting that plants and trees consist of an array of leaves supported by branches and stems and while each leave may be a flat collector, the array functions more like a spherical collector. Imagine each plant being approximated as a green sphere of constant diameter. Then the energy intercepted by each plant would not depend on the direction from which the radiance came. This would cause the formula for the distribution to be reduced by one factor of cos(θ). So for a point source the ideal distribution would vary as 1/cos²(θ) and for the linear source the ideal distribution would vary as 1/cos(θ).

Of course, plants and trees are not opaque spheres, however the array of leaves when seen from a distance does approximate a sphere. This is because plants have evolved to maximize collection of energy from a moving source, the sun. As the sun transits the sky, the projected area of the tree structure in the direction of the sun remains roughly constant. In FIG. 13 we see that the projected area of the absorbing spheres is constant, independent of position.

Real plants in a horticultural situation will lie somewhere between the two. For growers who think in terms of canopy, the horizontal model is best. For growers who space out their plants, the spherical model may be best. In any event, either distribution can be approximated using the concept of two linear arrays displaced by an angle. The angle would be varied with larger angles approximating the less pointed batwing. There may be an optimal angle that accommodates the fact that the model for real plants lies somewhere between horizontal flat plate absorbers and spherical absorbers.

Table 1. summarized the angular dependency for ideal Batwing distributions for point sources and linear sources for both flat plate and spherical absorber models.

TABLE 1
Batwing angular functionality for various
combinations of sources and absorber models

| Source Geometry | Point Source | Linear Source |
|---|---|---|
| Flat plate absorber | 1/cos³(θ) | 1/cos²(θ) |
| Spherical absorber | 1/cos²(θ) | 1/cos(θ) |

The shape of the batwing profile for the linear source and aspherical absorber is shown in FIG. 14. Compare to FIG. 2 and FIG. 6.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A lighting system (100), comprising:
a) a linear support structure (300) comprising a first support plane (310) attached at an angle in the range of 80 to 100 degrees with a second support plane (320); and
b) a first linear array of LEDs (200) disposed upon the first support plane and a second linear array disposed upon the second support plane.

2. The lighting system of claim 1 wherein the first and second linear array of LEDs each have a beam in the range of 70 to 90 degrees.

3. The lighting system of claim 1 configured to produce uniform flux density of illumination on a horizontal surface, the horizontal surface disposed below the lighting system.

4. The lighting system of claim 1 further comprising an external flat defector (400) disposed over the linear support structure.

5. The lighting system of claim 1 wherein the first and second linear arrays of LEDs each have a beam in the range of 115 to 125 degrees.
